(19) United States
(12) Patent Application Publication
(10) Pub. No.: US 2007/0172576 A1
(43) Pub. Date: Jul. 26, 2007

(54) Restructured meat product

(76) Inventor: Antonio Mata, North Richland Hills, TX (US)

Correspondence Address: HOVEY WILLIAMS LLP, 2405 GRAND BLVD., SUITE 400, KANSAS CITY, MO, 64108, US

(21) Appl. No.: 11/337,859

(22) Filed: Jan. 23, 2006

(51) Int. Cl. A23L 1/31

(52) U.S. Cl. 426/646

(57) ABSTRACT

Improved restructured meat products are provided which exhibit enhanced texture, tenderness, juiciness, and flavor. The meat products are formed by mixing together brine-treated, essentially gristle free raw meat strips (e.g., beef, poultry, pork or mixtures thereof) in the form of strips and ground beef containing naturally-occurring fat, followed by forming the mixture into steak-like bodies.

### BACKGROUND OF THE INVENTION

1. Field of the Invention

The present invention is broadly concerned with restructured meat products which can be formed into steak-like products having improved texture, flavor, and juiciness. More particularly, the invention is concerned with such meat products, and methods of forming the product, wherein the products include respective fractions of substantially gristle-free meat in the form of thin strips, and ground meat containing substantial naturally occurring fat.

2. Description of the Prior Art

Restructured meat products have been produced in the past to achieve a variety of ends. Current restructuring technologies yield products which are deficient in one or more respects, e.g., rubbery texture, tightly bound juices, low meat flavor, limited raw material flexibility, significant product dryness or toughness cooked above medium degrees of doneness, and undue surface area shrinkage. As a consequence, prior restructured meat products have exhibited less than optimum performance.

A number of prior patents describe restructured meat products. U.S. Patent Application Publication No. 2002/0048622 to Baarada et al. describes composite meat products formed using raw trimmed meat which is macerated and marinated, followed by the addition of relatively small quantities of powdered fat. U.S. Pat. No. 4,539,210 discloses restructured meat products formed using meat chunks and fat particles. Ground fat trimmings are blended into an emulsion which is co-extruded with the lean meat to produce a fat cap. U.S. Pat. No. 4,377,597 discloses a restructured meat product designed to resemble roast beef. The product is made up of beef strips and chunks, and chopped beef binder.

Other prior art references describing various meat products include U.S. Pat. Nos. 5,690,989, 5,631,035 5,472,725, 5,100,680, 4,874,623, 5,017,393, 4,975,294, 4,927,661, 4,820,535, 4,810,514, 4,731,906, 4,610,844, 4,728,524, 4,603,053, 4,363,822, 4,258,068, 4,210,677, 4,072,763, 4,036,997, 3,911,154, 3,852,507, 3,769,036, 3,683,793, and 3,573,062.

### SUMMARY OF THE INVENTION

The present invention overcomes the problems outlined above and provides greatly improved restructured meat products which have enhanced texture, juiciness and natural meat flavor. The products can be prepared using a variety of raw materials and with consistent, reproducible portion sizes.

The method of the invention broadly includes the steps of first providing a substantially gristle-free raw meat in the form of strips having thickness dimensions less than the length and width dimensions thereof. Next, a brine system is added to the meat strips comprising water, salt and a phosphate source, and the brine system is allowed to substantially completely absorb into the meat strips. Ground beef containing naturally-occurring fat is added to the meat strips with mixing to form a substantially homogeneous mixture. This mixture is then formed into steak-like bodies. Such forming may involve vacuum stuffing into conventional casings, followed by freezing, tempering, removal of the casing, and final molding and/or slicing. Alternately, the steak-like bodies can be directly formed using vacuum forming equipment.

The resultant restructured steak-like meat product generally has a thickness of up to about ¾ in. and can be formed to simulate whole muscle cuts such as strip or sirloin steaks. These products are tender, juicy, and have improved beef flavor.

### DETAILED DESCRIPTION OF THE PREFERRED EMBODIMENT

The following example sets forth presently preferred techniques for preparing the restructured meat products of the invention. It is to be understood, however, that these examples are provided by way of illustration and nothing therein should be taken as a limitation upon the overall scope of the invention.

### Example

Restructured steak-like beef products were produced and tested. The final product formulation was: lean beef strips, 45% by weight, ground beeftrimmings, 40% by weight, water, 13.8% by weight, salt, 1% by weight and phosphate (a mixture of tripolyphosphate and hexametaphosphate), 0.2% by weight.

The lean beef strips had thickness dimensions in the range of about 1/16- 3/32 in., width dimensions of ¼-½ in., and length dimensions of from about 1-3 in. The lean strips were prepared by removing essentially all fat and gristle from lean beef, followed by cutting the large muscle product into small slabs having a thickness of about ½ in. (+/−¼ in.) a width of from about 2-4 in. and a length of from about 2-4 in. The slabs were then mechanically sliced to give the above strip dimensions.

The prepared beef strips were then vacuum mixed for a period of about 5-7 minutes with a brine system made up of the water, salt and phosphate until brine system had been absorbed by the strips.

Next, the ground trimmings and brine system-treated beef strips were mixed under vacuum for a period of about 2-3 minutes until a uniform blend was achieved. The ground trimmings were ground through a ⅛ in. plate and had a fat content of from about 10-50% by weight.

Next, the lean strip/trimmings mixture was vacuum stuffed into impermeable (polypropylene) casings and frozen at below about 0° F. The frozen product was then tempered to about 26° F. in a refrigerator, and the casings were removed. The tempered product was then molded using conventional equipment and then sliced into steak-like products having thickness dimensions of from about 0.4-0.75 in., length dimensions of from about 4-8 in., and width dimensions of from about 3-4 in.

It was found that the restructured products could be cooked to a high degree of doneness (above 160° F.) while remaining juicy. The products also exhibited significant improvements in texture and flavor as compared with existing restructured meat products.

In other tests, the above method was followed except that different meat strips were employed. Specifically, defatted chicken thigh, turkey breast, and pork cushion meat strips were used in lieu of beef. However, the products were made with ground beef trimmings, such that the resultant products had a beef flavor.

It is also possible to employ beef or other meat strips which are not fully defatted, so long as substantially all gristle is removed. In one such test, beef brisket was sliced to form the starting meat strips, without defatting. Beef brisket is a relatively high fat beef product, but contains little or no gristle. The resulting product was very acceptable from the standpoint of texture, flavor, and juiciness.

The invention is susceptible to a variety of variations in product formulation and processing. As noted above, while the meat fraction of the products may consist essentially of beef, in other forms the meat strip fraction may be selected from the group consisting of beef, poultry, pork and mixtures thereof. The meat strips used in the invention may have thickness dimensions of from about 2/32- 7/32 in., width dimensions of from about ¼-¾ in., and length dimensions of from about ¾-2 in. The meat strips may also be essentially free of both fat and gristle. Where beef is used as the source of meat strips, it may be obtained from a variety of cuts, such as knuckles, top round, bottom round, full-fat brisket, and mixtures thereof.

The ground meat fraction should contain naturally-occurring fat at a level of from about 10-75% by weight, and more preferably from about 30-60% by weight. This meat should be ground through a plate having hole sizes of from about 1/16-¼ in., more preferably about ⅛ in., so that the resulted ground meat has corresponding average diameters.

The meat and brine system mixture (and the final products) should contain from about 40-75% by weight of the meat strips, and from about 40-75% by weight of the ground meat. Most preferably, the lean and ground meat should be present in substantially equal amounts. The salt content should be from about 0.5-1.25% by weight, and the phosphate content should be from about 0.1-0.3% by weight. The water content should range from about 5-25% by weight, and more preferably from about 10-15% by weight. The final steak-like product should have a thickness of from about ¼-¾ in., with variable length and width dimensions depending upon the desired product configuration.

If desired, the frozen product may be molded prior to slicing to obtain specialized shapes simulating whole muscle meat cuts. Also, a “D” shape may be achieved by a “slack fill” at the time of stuffing under vacuum into the casing, followed by laying the stuffed casing on a flat surface during the freezing step.

In some instances, the products of the invention can be produced without the need for the casing, freezing, and tempering steps described above. Generally, this requires the use of vacuum forming machines such as those used in the mass production of beef patties. Suitable equipment includes VacForm Models 400, 600, and 900, commercialized by DeJong Engineering of Elburg, Holland, and Vemag vacuum stuffers commercialized by Robert Reiser International of Canton, Mass.

I claim:

1. A method of forming a restructured meat product, comprising the steps of:
providing a substantially gristle-free raw meat in the form of strips having thickness dimensions less than the length and width dimensions thereof;
adding a brine system to said meat strips comprising water, salt and a phosphate source, and allowing the meat strips to absorb the brine system;
adding ground beef containing naturally-occurring fat to said meat strips, and mixing the ground beef and meat strips together to form a substantially homogeneous mixture; and
forming said homogeneous mixture into discrete bodies.

2. The method of claim 1, said meat strips selected from the group consisting of beef, poultry, pork and mixtures thereof.

3. The method of claim 2, said meat strips consisting essentially of beef.

4. The method of claim 1, said strips having thickness dimensions of from about 2/32- 7/32″.

5. The method of claim 1, said strips having width dimensions of from about ¼-¾″, and length dimensions of from about ¾-2.0″.

6. The method of claim 1, said meat strips having a fat content of up to about 3% by weight.

7. The method of claim 1, said ground beef having a fat content of from about 10-75% by weight.

8. The method of claim 7, said fat content being from about 30-60% by weight.

9. The method of claim 1, said ground beef comprising ground beef trimmings.

10. The method of claim 9, said ground beef consisting essentially of beef trimmings.

11. The method of claim 1, said mixture including from about 40-75% by weight of said meat strips, and from about 40-75% by weight of said ground beef.

12. The method of claim 11, said mixture including substantially equal amounts of said meat strips and said ground beef.

13. The method of claim 1, said ground beef having an average diameter of from about 1/16-¼ in.

14. The method of claim 13, said ground beef having an average diameter about ⅛ in.

15. The method of claim 1, said phosphate source selected from the group consisting of trimetaphosphate and hexametaphosphate.

16. The method of claim 1, said mixture having a salt content of from about 0.5-1.25% by weight, and a phosphate content of from about 0.1-0.3% by weight.

17. The method of claim 1, said mixture having a water content of from about 5-25% by weight.

18. The method of claim 17, said water content being from about 10-15% by weight.

19. The method of claim 1, said forming step comprising the steps of vacuum stuffing the mixture into casings, freezing the vacuum-encased mixture, tempering the frozen and vacuum-encased mixture, removing the tempered mixture from the casings, and molding the tempered mixture.

20. The method of claim 1, including the step of forming the mixture into a steak-like product having a thickness of from about ¼-¾ in.

21. A restructured meat product comprising a formed meat body including substantially gristle-free meat in the form of strips having thickness dimensions less than the length and width dimensions thereof, ground beef containing naturally occurring fat substantially homogeneously mixed with said meat strips, water, salt and a phosphate source, said body being formed as steak-like products and having a maximum thickness of up to about ¾ in.

22. The product of claim 21, said meat strips selected from the group consisting of beef, poultry, pork and mixtures thereof.

23. The product of claim 22, said meat strips consisting essentially of beef.

24. The product of claim 21, said strips having thickness dimensions of from about 2/32- 7/32 in.

25. The product of claim 21, said strips having width dimensions of from about ¼-¾ in., and length dimensions of from about ¾-2.0 in.

26. The product of claim 21, said meat strips having a fat content of up to about 3% by weigh.

27. The product of claim 21, said ground beef having a fat content of from about 10-75% by weight.

28. The product of claim 27, said fat content being from about 30-60% by weight.

29. The product of claim 21, said ground beef comprising beef trimmings.

30. The product of claim 29, said ground beef consisting essentially of beef trimmings.

31. The product of claim 21, said body including from about 40-75% by weight of said meat strips, and from about 40-75% by weight of said ground beef.

32. The product of claim 31, said body including substantially equal amounts of said meat strips and said ground beef.

33. The product of claim 21, said ground beef having an average diameter of from about 1/16-¼ in.

34. The product of claim 33, said ground beef having an average diameter about ⅛ in.

35. The product of claim 21, said phosphate source selected from the group consisting of trimetaphosphate and hexametaphosphate.

36. The product of claim 21, said body having a salt content of from about 0.5-1.25% by weight, and a phosphate content of from about 0.1-0.3% by weight.

37. The product of claim 21, said body having a water content of from about 5-25% by weight.

38. The product of claim 37, said water content being from about 10-15% by weight.
